(19) United States
(12) Patent Application Publication
(10) Pub. No.: US 2024/0085010 A1
(43) Pub. Date: Mar. 14, 2024

(54) LIGHT-EMITTING DEVICE

(71) Applicant: FUJIFILM Business Innovation Corp., Tokyo (JP)

(72) Inventor: Motohiro ASANO, Kanagawa (JP)

(73) Assignee: FUJIFILM Business Innovation Corp., Tokyo (JP)

(21) Appl. No.: 18/157,477

(22) Filed: Jan. 20, 2023

(30) Foreign Application Priority Data
Sep. 9, 2022 (JP) 2022-143482

(51) Int. Cl. F21V 29/70

(52) U.S. Cl. CPC F21V 29/70; F21Y 2115/15

(57) ABSTRACT

A light-emitting device includes a light source that outputs light, a light-guiding unit that guides the light from the light source to a predetermined position, and a heat-absorbing member that is disposed between the light source and the light-guiding unit and that absorbs some or all of heat of the light while allowing the light to pass through the heat-absorbing member.

### CROSS-REFERENCE TO RELATED APPLICATIONS

This application is based on and claims priority under 35 USC 119 from Japanese Patent Application No. 2022-143482 filed Sep. 9, 2022.

### BACKGROUND

### (i) Technical Field

The present disclosure relates to a light-emitting device.

### (ii) Related Art

There is known a technology for reading an image formed on a document with a scanner sensor (see, for example, Japanese Unexamined Patent Application Publication No. 2020-22098). In such a technology, a light guide guides light from a light source to a light-emitting unit, and light is radiated from the light-emitting unit onto a document. Some of the light is reflected by the document and read by a scanner sensor. Here, although the light source and the light guide are arranged close to each other in order to efficiently cause the light from the light source to enter the light guide, the light source and the light guide are spaced apart from each other in order to prevent them from breaking as a result of coming into contact with each other.

Although the light source is required to have an output suitable for the performance of the device, since the light source and the light guide are arranged close to each other, there is a possibility that the light guide may become thermally deformed depending on the output of the light source. In contrast, if the light guide is separated from the light source in order to prevent such thermal deformation, there is a possibility that the amount of light that enters the light guide may be reduced, making it difficult to maintain an intended reading quality.

### SUMMARY

Aspects of non-limiting embodiments of the present disclosure relate to further suppression of thermal deformation of a light guide that may occur when the output of a light source positioned close to the light guide is increased compared with the case in which there is no member present between the light source and the light guide.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a light-emitting device including a light source that outputs light, a light-guiding unit that guides the light from the light source to a predetermined position, and a heat-absorbing member that is disposed between the light source and the light-guiding unit and that absorbs some or all of heat of the light while allowing the light to pass through the heat-absorbing member.

### BRIEF DESCRIPTION OF THE DRAWINGS

An exemplary embodiment of the present disclosure will be described in detail based on the following figures, wherein:

FIGS. 1A and 1B are respectively a perspective view illustrating an example of the external configuration of a contact image sensor (CIS) of the related art and an enlarged view of a portion of the CIS that is surrounded by a circle frame in FIG. 1A when viewed in a different direction;

FIGS. 2A and 2B are diagrams illustrating the positional relationship between light sources and light guides that are included in a CIS of the related art;

FIG. 3 is a diagram illustrating an example of the external configuration of a CIS serving as a light-emitting device to which the present exemplary embodiment is applied;

FIGS. 4A and 4B are respectively a diagram illustrating a specific example of the positional relationship between a light source, a light-guiding unit, and a heat-absorbing member that are included in the CIS of the present exemplary embodiment and a diagram illustrating a state in which the temperature of a light-emitting surface of the light source has increased; and

FIG. 5 is a diagram illustrating an example of the positional relationship between the light source, the light-guiding unit, and the heat-absorbing member different from their positional relationship illustrated in FIG. 4A.

### DETAILED DESCRIPTION

An exemplary embodiment of the present disclosure will be described in detail below with reference to the accompanying drawings.

### (Configuration of CIS of Related Art)

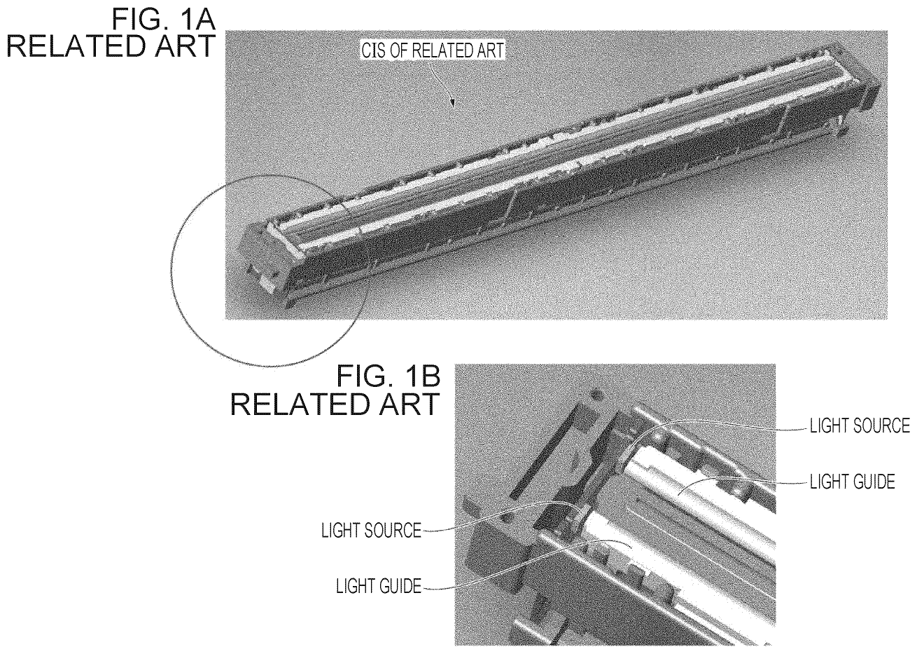

FIG. 1A is a perspective view illustrating an example of the external configuration of a contact image sensor (CIS) of the related art. FIG. 1B is an enlarged view of a portion of the CIS that is surrounded by a circle frame in FIG. 1A when viewed in a different direction.

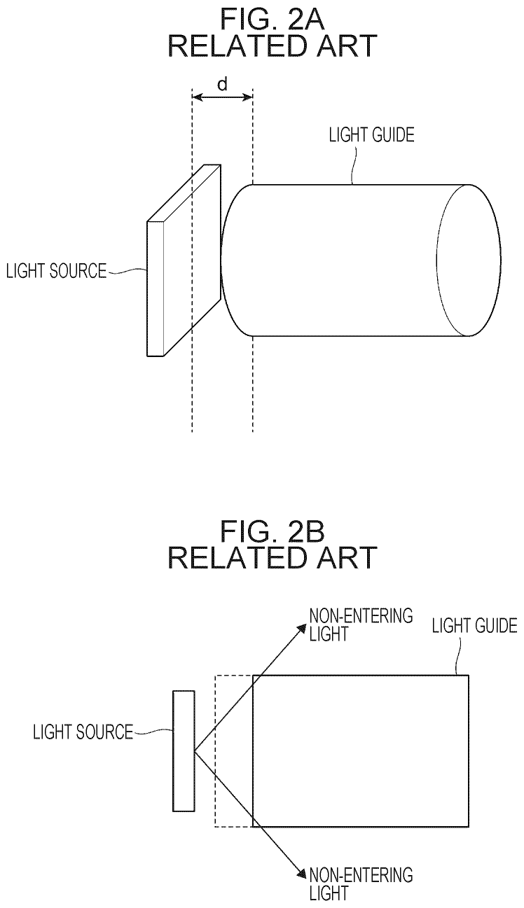

FIGS. 2A and 2B are diagrams illustrating the positional relationship between light sources and light guides that are included in a CIS of the related art.

A CIS of the related art is a light-emitting device in which a light source, a lens, and a light receiving element are integrated with one another and is used as an image sensor that is included in an image reading device and that employs a contact optical system. As illustrated in FIGS. 1A and 1B, a CIS of the related art includes light sources each of which is formed of a light-emitting diode (LED) or the like and light guides that guide light output by the light sources to a predetermined position. Each of the light guides is made of a transparent resin and has a bar-like shape, and the light guides are arranged in the vicinity of their respective light sources so as not to come into contact with the light sources.

More specifically, as illustrated in FIG. 2A, the light guides are arranged in such a manner that a gap d is formed between each of the light guides and the corresponding light source. There are two reasons why the gap d is formed between each of the light guides and the corresponding light source. One of the reasons is to prevent the light source and the light guide from breaking or the like as a result of coming into contact with each other. The other reason is to prevent the light guide from melting and becoming deformed by being affected by an increase in the temperature of a light-emitting surface of the light source that is caused by the light source and the light guide coming close to each other.

However, if the light source and the light guide are spaced too far apart from each other by increasing the gap d, as illustrated in FIG. 2B, the amount of light that is output by the light source and that does not enter the light guide increases, and accordingly, the amount of light that enters the light guide is reduced, so that there is a possibility that an illumination function may deteriorate. More specifically, the radiation angle of the light output by the light source is about 60 degrees, and the diameter of the light guide is about 3 millimeters (mm). Thus, in the CIS of the related art, the light sources and the light guides are arranged in such a manner that the gap d is set to about 0.8 mm to about 1 mm. However, depending on the environments in which the CIS of the related art is placed or the output of each light source, it may be difficult to avoid the above-mentioned risks simply by forming the gap d.

### Configuration of CIS to which Present Exemplary Embodiment is Applied

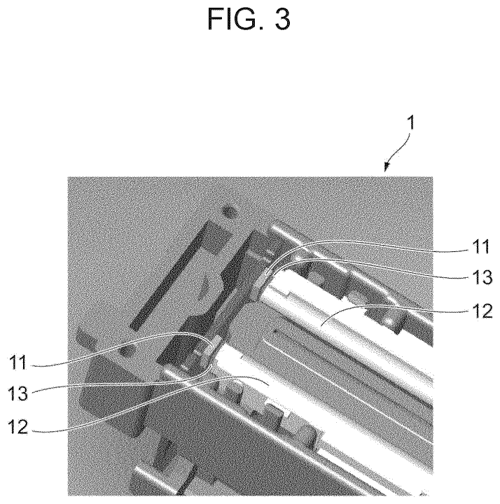

FIG. 3 is a diagram illustrating an example of the external configuration of a CIS 1 serving as a light-emitting device to which the present exemplary embodiment is applied. Note that FIG. 3 corresponds to FIG. 1B, which has been mentioned above.

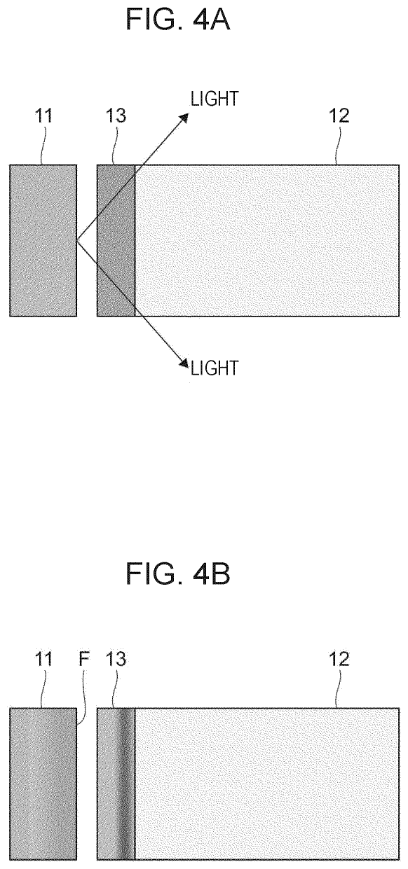

FIG. 4A is a diagram illustrating a specific example of the positional relationship between one of light sources 11, one of light-guiding units 12, and one of heat-absorbing members 13 that are included in the CIS 1. FIG. 4B is a diagram illustrating a state in which the temperature of a light-emitting surface F of one of the light sources 11 has increased.

Similar to the above-described CIS of the related art, which is illustrated in FIGS. 1A and 1B, the CIS 1 that serves as a light-emitting device to which the present exemplary embodiment is applied is a light-emitting device in which light sources, a lens, and a light receiving element are integrated with one another and is used as an image sensor that is included in an image reading device and that employs a contact optical system. The CIS 1 includes the light sources 11 each of which has a function similar to that of each of the light sources included in the CIS of the related art illustrated in FIG. 1B, the light-guiding units 12 each of which has a function similar to that of each of the light guides that are included in the CIS of the related art illustrated in FIG. 1B, and the heat-absorbing members 13.

As illustrated in FIG. 4A, the heat-absorbing members 13 are members each of which is disposed between one of the light sources 11 and the corresponding light-guiding unit 12. As illustrated in FIG. 4B, each of the heat-absorbing members 13 absorbs some or all of the heat of light output by the corresponding light source 11 while allowing the light to pass therethrough so as to reduce the probability that the temperature of the corresponding light-guiding unit 12 will be increased as a result of the light source 11 and the light-guiding unit 12 coming close to each other. Thus, heat-resistant members having a lower thermal conductivity than air are used as the heat-absorbing members 13. Examples of the materials of the heat-resistant members having a lower thermal conductivity than the air include transparent glass and a transparent resin.

More specifically, only transparent glass may be used as the material of the heat-absorbing members 13, or only a transparent resin may be used as the material of the heat-absorbing members 13. Alternatively, both transparent glass and a transparent resin may be used as the materials of the heat-absorbing members 13. In the case of using both transparent glass and a transparent resin as the materials of the heat-absorbing members 13, for example, transparent glass members may be bonded to their respective light-guiding units 12 by transparent resin members such as plastic tapes each having an adhesive function. In addition, the heat-absorbing members 13 may be retrofitted to light-guiding units of a CIS of the related art.

It is only necessary that the heat-absorbing members 13 included in the CIS 1 each be disposed between one of the light sources 11 and the corresponding light-guiding unit 12, and thus, specific arrangement positions of the heat-absorbing members 13 are not particularly limited in regions between the light sources 11 and the light-guiding units 12. For example, as illustrated in FIG. 4A, each of the heat-absorbing members 13 may be in contact with the corresponding light-guiding unit 12 and may be separated from the corresponding light source 11. In this case, each of the heat-absorbing members 13 is disposed at a position indicated by a dashed line in FIG. 2B, which has been mentioned above, and thus, the amount of light that is output by the light source 11 and that enters the light-guiding unit 12 in the configuration illustrated in FIG. 4A is larger than that in the configuration illustrated in FIG. 2B, which has been mentioned above.

In the case where the heat-absorbing members 13 are brought into contact with their respective light-guiding units 12 as illustrated in FIG. 4A, each of the heat-absorbing members 13 may be disposed such that, for example, the thickness of the heat-absorbing member 13 is about 0.8 mm to about 1.0 mm, the distance between the light-guiding unit 12 and the light source 11 facing each other with the heat-absorbing member 13 interposed therebetween is 1.5 mm or smaller, and the distance between the heat-absorbing member 13 and the light source 11 is about 0.5 mm to about 0.7 mm.

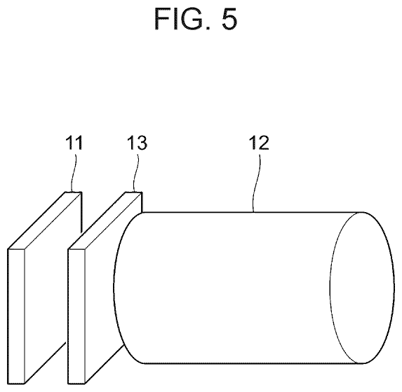

FIG. 5 is a diagram illustrating an example of the positional relationship between one of the light sources 11, one of the light-guiding units 12, and one of the heat-absorbing members 13 different from their positional relationship illustrated in FIG. 4A.

In the specific example of the positional relationship between the light source 11, the light-guiding unit 12, and the heat-absorbing member 13 illustrated in FIG. 4A, which has been mentioned above, the light source 11 and the heat-absorbing member 13 are not in contact with each other, and the heat-absorbing member 13 and the light-guiding unit 12 are in contact with each other. In contrast, in the specific example of the positional relationship between the light source 11, the light-guiding unit 12, and the heat-absorbing member 13 illustrated in FIG. 5, the heat-absorbing member 13 is in contact with neither the light source 11 nor the light-guiding unit 12.

In the case where the heat-absorbing member 13 is disposed at a position where it is in contact with neither the light-guiding unit 12 nor the light source 11, a gap is formed between the light source 11 and the heat-absorbing member 13, and a gap is formed between the heat-absorbing member 13 and the light-guiding unit 12. Thus, the heat dissipation effect in the configuration illustrated in FIG. 5 is higher than that in the configuration illustrated in FIG. 4A, which has been mentioned above.

In addition, the specific shape and the specific size of each of the heat-absorbing members 13 are not particularly limited. For example, each of the heat-absorbing members 13 may have a shape and a size different from those of the heat-absorbing member 13 illustrated in FIG. 4A in such a manner that the heat-absorbing member 13 has a higher light refractive index than air. For example, each of the heat-absorbing members 13 may have a shape and a size that enables the heat-absorbing member 13 to exhibit a light-converging effect. More specifically, although not illustrated, each of the heat-absorbing members 13 may have a semicircular shape. In this case, for example, one surface of each of the heat-absorbing members 13 may have a semicircular shape, and the other surface of each of the heat-absorbing members 13 may have a planar shape that is brought into contact with the corresponding light-guiding unit 12, so that the heat-absorbing members 13 may be easily arranged. Alternatively, each of the heat-absorbing members 13 may have a shape other than a semicircular shape. In this case, for example, converging lenses that function as the heat-absorbing members 13 may be arranged. The shape, the size, and the arrangement position of each of the heat-absorbing members 13 may be set in accordance with the positional relationship between the light sources 11 and the light-guiding units 12 before the heat-absorbing members 13 are arranged and the angle at which light output by the light sources 11 enters the light-guiding units 12.

### Other Exemplary Embodiments

Although the present exemplary embodiment has been described above, the present disclosure is not limited to the above-described exemplary embodiment. In addition, effects of the present disclosure are not limited to those of the above-described exemplary embodiment. For example, the configurations of the light sources 11, the light-guiding units 12, and the heat-absorbing members 13 illustrated in FIG. 3, FIG. 4A, FIG. 4B, and FIG. 5 are merely illustrative examples for achieving the object of the present disclosure and are not particularly limited. It is only necessary that the CIS that includes the light sources 11, the light-guiding units 12, and the heat-absorbing members 13 as its components has the above-mentioned functions, and the configuration for implementing the functions is not limited to those mentioned above as examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A light-emitting device comprising:
a light source that outputs light;
a light-guiding unit that guides the light from the light source to a predetermined position; and
a heat-absorbing member that is disposed between the light source and the light-guiding unit and that absorbs some or all of heat of the light while allowing the light to pass through the heat-absorbing member.
   (((2)))

The light-emitting device according to (((1))),
wherein the heat-absorbing member has a lower thermal conductivity than air.
   (((3)))

The light-emitting device according to (((1))) or (((2))),
wherein the heat-absorbing member is disposed at a position at which the heat-absorbing member is in contact with the light-guiding unit and is not in contact with the light source.
   (((4)))

The light-emitting device according to (((3))),
wherein the heat-absorbing member is disposed in such a manner as to be in contact with a surface of the light-guiding unit, the surface facing the light source, and a distance between the heat-absorbing member and the light source is 0.5 millimeters (mm) to 0.7 mm.
   (((5)))

The light-emitting device according to (((3))),
wherein the heat-absorbing member is disposed at a position at which the heat-absorbing member is in contact with neither the light-guiding unit nor the light source.
   (((6)))

The light-emitting device according to any one of (((1))) to (((5))),
wherein a distance between the light-guiding unit and the light source facing each other with the heat-absorbing member interposed between the light-guiding unit and the light source is 1.5 millimeters (mm) or smaller.
   (((7)))

The light-emitting device according to any one of (((1))) to (((6))),
wherein the heat-absorbing member has a higher light refractive index than air.
   (((8)))

The light-emitting device according to (((7))),
wherein a shape, a size, and an arrangement position of the heat-absorbing member are set in accordance with a positional relationship between the light source and the light-guiding unit before the heat-absorbing member is disposed and an angle at which the light enters the light-guiding unit.
   (((9)))

The light-emitting device according to (((7))) or (((8))),
wherein the heat-absorbing member has a semicircular shape.
   (((10)))

The light-emitting device according to any one of (((1))) to (((9))),
wherein the light source is a light-emitting diode (LED),
wherein the light-guiding unit is a light guide made of a resin, and
wherein the heat-absorbing member is a member containing at least one of transparent glass and a transparent resin.

What is claimed is:

1. A light-emitting device comprising:
a light source that outputs light;
a light-guiding unit that guides the light from the light source to a predetermined position; and
a heat-absorbing member that is disposed between the light source and the light-guiding unit and that absorbs some or all of heat of the light while allowing the light to pass through the heat-absorbing member.

2. The light-emitting device according to claim 1,
wherein the heat-absorbing member has a lower thermal conductivity than air.

3. The light-emitting device according to claim 2,
wherein the heat-absorbing member is disposed at an arrangement position at which the heat-absorbing member is in contact with the light-guiding unit and is not in contact with the light source.

4. The light-emitting device according to claim 3,
wherein the heat-absorbing member is disposed in such a manner as to be in contact with a surface of the light-guiding unit, the surface facing the light source, and a distance between the heat-absorbing member and the light source is 0.5 millimeters (mm) to 0.7 mm.

5. The light-emitting device according to claim 3,
wherein the arrangement position of the heat-absorbing member is a position at which the heat-absorbing member is in contact with neither the light-guiding unit nor the light source.

6. The light-emitting device according to claim 1,
wherein a distance between the light-guiding unit and the light source facing each other with the heat-absorbing member interposed between the light-guiding unit and the light source is 1.5 millimeters (mm) or smaller.

7. The light-emitting device according to claim 6,
wherein the heat-absorbing member has a higher light refractive index than air.

8. The light-emitting device according to claim 7,
wherein a shape, a size, and an arrangement position of the heat-absorbing member are set in accordance with a positional relationship between the light source and the light-guiding unit in a state in which the heat-absorbing member is not disposed and an angle at which the light enters the light-guiding unit.

9. The light-emitting device according to claim 8,
wherein the shape of the heat-absorbing member is a semicircular shape.

10. The light-emitting device according to claim 8,
wherein the light source is a light-emitting diode (LED),
wherein the light-guiding unit is a light guide made of a resin, and
wherein the heat-absorbing member is a member containing at least one of transparent glass and a transparent resin.

11. A light-emitting device comprising:
a light source that outputs light;
light-guiding means for guiding the light from the light source to a predetermined position; and
a heat-absorbing member that is disposed between the light source and the light-guiding means and that absorbs some or all of heat of the light while allowing the light to pass through the heat-absorbing member.
